(19) United States
(12) Patent Application Publication
(10) Pub. No.: US 2021/0356168 A1
(43) Pub. Date: Nov. 18, 2021

(54) FILTER SCREEN RAIL MODULE, CLEANING MEMBER, INDOOR UNIT OF AIR CONDITIONER, AND AIR CONDITIONER

(71) Applicants: GD MIDEA AIR-CONDITIONING EQUIPMENT CO., LTD., Foshan (CN); MIDEA GROUP CO., LTD., Foshan (CN)

(72) Inventors: Gen LU, Foshan (CN); Zecheng SUN, Foshan (CN); Shuyang PI, Foshan (CN); Huajun ZHANG, Foshan (CN)

(73) Assignees: GD MIDEA AIR-CONDITIONING EQUIPMENT CO., LTD., Foshan (CN); MIDEA GROUP CO., LTD., Foshan (CN)

(21) Appl. No.: 17/388,615

(22) Filed: Jul. 29, 2021

Related U.S. Application Data
(63) Continuation of application No. PCT/CN2019/112426, filed on Oct. 22, 2019.

(30) Foreign Application Priority Data
Jan. 31, 2019 (CN) 201920179257.6

(51) Int. Cl. F24F 13/28; F24F 1/0073; B01D 46/00; B01D 46/44

(52) U.S. Cl. CPC F24F 13/28; F24F 1/0073; B01D 46/0072; B01D 2279/50; B01D 46/44; B01D 46/0082; F24F 2221/22; B01D 46/0006

(57) ABSTRACT

A filter screen rail module, a cleaning member, an indoor unit of an air conditioner, and an air conditioner are provided. The filter screen rail module is applied to the indoor unit of the air conditioner. The indoor unit of the air conditioner includes a face frame defining an air inlet. The filter screen rail module is disposed adjacent to the air inlet. The filter screen rail module is separable from the face frame. The filter screen rail module is provided with a guiding space, in which the filter screen moves.

### CROSS REFERENCE TO RELATED APPLICATIONS

The present application is a continuation application of PCT International Application No. PCT/CN2019/112426, filed on Oct. 22, 2019, which claims the priority of Chinese Application No. 201920179257.6, entitled “FILTER SCREEN RAIL MODULE, CLEANING MEMBER, INDOOR UNIT OF AIR CONDITIONER, AND AIR CONDITIONER”, filed on Jan. 31, 2019, the entire contents of which are hereby incorporated by reference. No new matter has been introduced.

### TECHNICAL FIELD

The present disclosure relates to the technical field of air conditioners, and in particular, to a filter screen rail module, a cleaning member, an indoor unit of an air conditioner, and an air conditioner.

### BACKGROUND

In order to clean the filter screen, it is necessary to provide a cleaning module in the indoor unit of the air conditioner. The cleaning module is configured to drive the filter screen to move and clean the filter screen simultaneously. However, the rail required for the movement of the filter screen needs to be cooperated with the face frame, that is, the function of the filter screen can only be detected after the indoor unit of the air conditioner is assembled.

The statements herein merely provide background information related to the present disclosure and do not necessarily constitute prior art.

### SUMMARY

The main objective of the present disclosure is to provide a filter screen rail module, a cleaning member, an indoor unit of an air conditioner, and an air conditioner, which aims to solve the problem of inconvenient detection on the function of the filter screen.

In order to achieve the above objective, the present disclosure provides a filter screen rail module, applied to an indoor unit of an air conditioner. The indoor unit of the air conditioner includes a face frame defining an air inlet. The filter screen rail module is disposed adjacent to the air inlet, the filter screen rail module is separable from the face frame, and the filter screen rail module is provided with a rail in which the filter screen moves.

In an embodiment of the present disclosure, the rail includes a first rail and a second rail communicating with the first rail;

the filter screen rail module includes:

a first grille and a second grille spaced apart from the first grille; and

an intermediate grille disposed between the first grille and the second grille, the first rail is defined between the first grille and the intermediate grille, the second rail is defined between the second grille and the intermediate grille, and the filter screen is movable in the first rail and the second rail.

In an embodiment of the present disclosure, a mounting space for accommodating a cleaning module is defined by the first grille, the second grille and the intermediate grille cooperatively. The first rail is in communication with the second rail through the mounting space, and the cleaning module is configured to drive the filter screen to move in the first rail and the second rail to clean the filter screen.

In an embodiment of the present disclosure, an end of the first grille is outwardly protruded with respect to an end of the intermediate grille and an end of the second grille, and the mounting space is defined by the end of the first grille, the end of the intermediate grille, and the end of the second grille cooperatively.

In an embodiment of the present disclosure, the first grille is detachably connected to the second grille.

In an embodiment of the present disclosure, the first grille is connected to the second grille through at least one connection selected from a snap connection, a screw-slot connection, a magnetic connection, or a sliding connection.

In an embodiment of the present disclosure, the intermediate grille is detachably connected to the first grille and/or the second grille.

In an embodiment of the present disclosure, the intermediate grille is connected to the first grille and/or the second grille through at least one connection selected from a snap connection, a screw-slot connection, a magnetic connection, or a sliding connection.

The present disclosure further provides a cleaning member, including a filter screen rail module of any of the above embodiments.

In an embodiment of the present disclosure, the cleaning member further including:

a filter screen disposed on the rail; and

a cleaning module mounted on the filter screen rail module, the filter screen is connected to the cleaning module, and the cleaning module is configured to drive the filter screen to move in the rail for cleaning the filter screen.

In an embodiment of the present disclosure, the cleaning member further includes a detecting device disposed on the filter screen rail module for detecting a motion state of the filter screen.

In an embodiment of the present disclosure, the detecting device is a micro switch, the cleaning module is mounted at one end of the filter screen rail module, and the micro switch is mounted at another end of the filter screen rail module. The filter screen is configured to trigger the micro switch in response to a determination that the filter screen is in contact with the micro switch.

The present disclosure further discloses an indoor unit of an air conditioner, including a cleaning member of any of the above embodiments.

In an embodiment of the present disclosure, the indoor unit of the air conditioner including:

a chassis, the cleaning member is mounted on the chassis; and

a face frame mounted on the chassis, the face frame is defined with an air inlet, the filter screen rail module is disposed adjacent to the air inlet, and the filter screen rail module is separable from the face frame.

In the technical solutions of the present disclosure, the filter screen rail module can be separated into separate components from the face frame. The filter screen rail module is provided with a rail in which the filter screen moves. Therefore, before the indoor unit of the air conditioner is assembled, the filter screen rail module can be installed with the cleaning module as a separate functional component for detecting the function of the filter screen.

### BRIEF DESCRIPTION OF THE DRAWINGS

In order to more clearly illustrate the embodiments of the present disclosure or the technical solutions in the related art, the drawings used in the embodiments or the related art will be briefly described below. Obviously, the drawings in the following description are only some embodiments of the present disclosure. It will be apparent to those skilled in the art that other figures can be obtained from the structures illustrated in the drawings without the inventive effort.

FIG. 1 is a schematic structural view of a filter screen rail module according to an embodiment of the present disclosure;

FIG. 2 is an enlarged view of the dotted line in FIG. 1;

FIG. 3 is an exploded view of the filter screen rail module according to the embodiment of the present disclosure; and

FIG. 4 is schematic structural view of a cleaning member according to an embodiment of the present disclosure.

### DESCRIPTION OF REFERENCE NUMERALS

| Reference numeral | Name |
|---|---|
| 100 | Cleaning member |
| 110 | Filter screen rail module |
| 111 | First grille |
| 112 | Second grille |
| 113 | Intermediate grille |
| 1101 | First guiding space |
| 1102 | Second guiding space |
| 1103 | Mounting space |
| 120 | Cleaning module |
| 130 | Filter screen |
| 140 | Detecting device |

The realization of the objective, functional characteristics, and advantages of the present disclosure are further described with reference to the accompanying drawings.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. Based on the embodiments of the present disclosure, all other embodiments obtained by those skilled in the art without creative efforts are within the scope of the present disclosure.

It is to be understood that, all of the directional instructions in the embodiments of the present disclosure (such as top, bottom, left, right, front, rear . . . ) can only be used for explaining relative position relations, moving condition of the elements under a special form (referring to figures), and so on, if the special form changes, the directional instructions changes accordingly.

In the present disclosure, unless otherwise expressly stated and limited, the terms “connected”, “fixed”, etc. should be understood broadly. For example, “fixed” may be a fixed connection, or may be a detachable connection, or integrated; may be a mechanical connection or an electrical connection; may be directly connected or indirectly connected through an intermediate medium, and may be internal communication of two elements or an interaction relationship of two elements, unless explicitly defined otherwise. For those skilled in the art, the specific meanings of the above terms of the present disclosure can be understood according to the specific conditions.

In addition, the descriptions, such as the “first”, the “second” in the embodiments of present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. Besides, the technical solution of each embodiment can be combined with each other, however the technical solution must base on that the ordinary skill in that art can realize the technical solution, when the combination of the technical solutions is contradictory or cannot be realized, it should consider that the combination of the technical solutions does not exist, and is beyond the protection scope of the present disclosure.

The present disclosure provides a filter screen rail module 110.

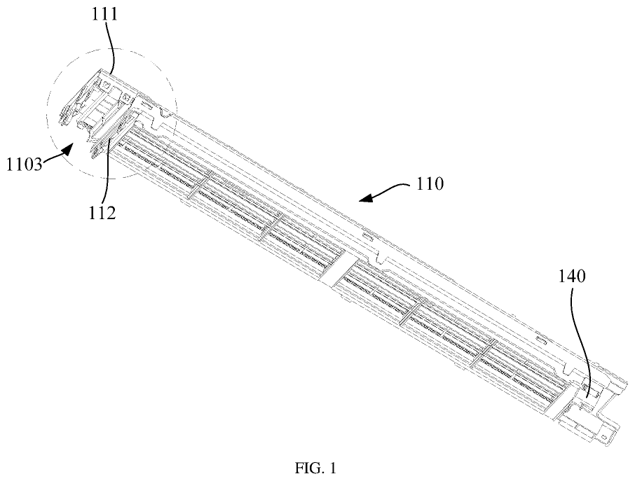

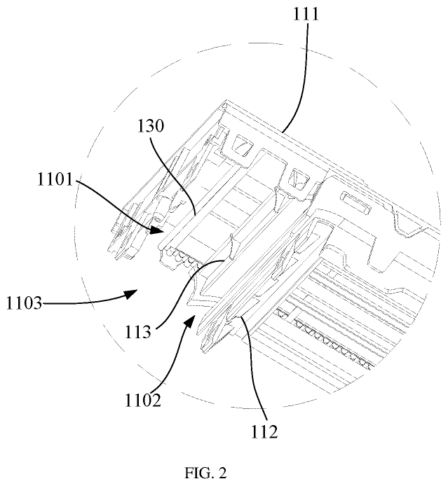

In an embodiment of the present disclosure, as shown in FIG. 1 and FIG. 2, the filter screen rail module 110 is applicable to an indoor unit of an air conditioner. The indoor unit of the air conditioner includes a face frame (not shown) defining an air inlet. The filter screen rail module 110 is disposed adjacent to the air inlet. The filter screen rail module 110 is separable from the face frame. The filter screen rail module 110 is provided with a guiding space (1101 and 1102) in which the filter screen 130 moves.

It should be understood that, in the current technology, a filter screen rail module is a structure, in which a filter screen moves, and needs to cooperate with a face frame to form a corresponding rail. The filter screen moves under the driving of a cleaning module. The air passing through the filter screen rail module is filter screened by the filter screen placed in the filter screen rail module while the indoor unit of the air conditioner is in operation.

However, in the present embodiment, the filter screen rail module 110 forms a guiding space (1101 and 1102, a space in which the filter screen moves), without the face frame. In other words, the filter screen rail module 110 is a separate component that is separable from the face frame. Before the indoor unit of the air conditioner is assembled, the filter screen rail module 110 is combined with the cleaning module 120. Therefore, when the function of the filter screen 130 is tested, the problem of the movement of the filter screen 130 can be found in time, thereby avoiding detecting the function of the filter screen 130 only after the indoor unit of the air conditioner is assembled.

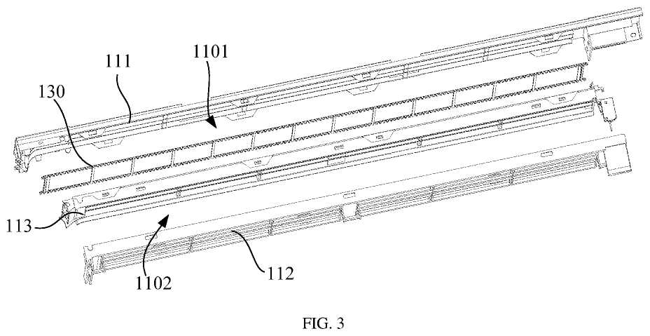

Specially, as shown in FIGS. 1 to 3, the rail includes a first guiding space 1101 and a second guiding space 1102.

The filter screen rail module 110 includes:

a first grille 111 and a second grille 112 spaced apart from the first grille 111; and

an intermediate grille 113 disposed between the first grille 111 and the second grille 112. The first guiding space 1101 is defined between the first grille 111 and the intermediate grille 113. The second guiding space 1102 is defined between the second grille 112 and the intermediate grille 113. The first guiding space 1101 is in communication with the second guiding space 1102, and the filter screen 130 is movable in the first guiding space 1101 and the second guiding space 1102.

In the present embodiment, the first grille 111, the intermediate grille 113 and the second grille 112 are cooperated to form the first guiding space 1101 and the second guiding space 1102 that are in communication with each other. The filter screen 130 is moveable in the first guiding space 1101 and the second guiding space 1102, and can reciprocate between the first guiding space 1101 and the second guiding space 1102. For example, the filter screen 130 slides out of the first guiding space 1101 into the second guiding space 1102, or slides out of the second guiding space 1102 into the first guiding space 1101. For another example, the filter screen 130 circulates between the first guiding space 1101 and the second guiding space 1102.

For example, the cleaning module 120 has a driving mechanism for driving the movement of the filter screen 130, a cleaning mechanism for cleaning the filter screen, a water pump, a water chamber, and the like. The water pump draws the condensed water generated by the indoor unit of the air conditioner into the water chamber, the driving mechanism drives the filter screen to move, and the cleaning mechanism cleans the filter screen. When the indoor unit of the air conditioner is in operation, the air passes through the filter screen rail module 110 to contact the heat exchanger to exchange heat. The filter screen 130 is located within the first guiding space 1101 or the second guiding space 1102 of the filter screen rail module 110 such that the filter screen 130 filter screens the air. After the filter screen 130 is dirty, the cleaning module 120 drives the filter screen 130 to move and clean the filter screen. The specific structure of the cleaning module 120 can be referred to the applicant's other patent application before the filing date of the present disclosure.

In the present embodiment, the filter screen rail module 110 is separated for connecting with the cleaning module 120. As such, it is not necessary to form a rail in which the filter screen 130 moves with cooperating with the face frame, so that the function of the filter screen 130 can be detected before the indoor unit of the air conditioner is assembled.

For example, first, the intermediate grille 113 is connected to the second grille 112, and the second guiding space 1102 is defined between the intermediate grille 113 and the second grille 112. Subsequently, the first grille 111 is connected to the intermediate grille 113, and the first guiding space 1101 is defined between the first grille 111 and the intermediate grille 113. As such, the filter screen rail module 110 is assembled, and one end of the first guiding space 1101 is in communication with one end of the second guiding space 1102 to form a space for the filter screen 130 to move, and the filter screen 130 is placed in the first guiding space 1101. The filter screen rail module 110 is combined with the cleaning module 120. The first guiding space 1101 and the second guiding space 1102 are in communication with the water chamber of the cleaning module 120. The driving mechanism of the cleaning module 120 drives the filter screen 130 to move in the first guiding space 1101 and the second guiding space 1102. The cleaning mechanism of the cleaning module 120 cleans the filter screen 130 while the filter screen 130 is driven to move. Thus, the filter screen rail module 110 is a separate component, and the filter screen rail module 110 and the cleaning module 120 are combined into a cleaning member 100. The cleaning member 100 is a separate functional member so that the function of the filter screen 130 can be detected before assembling the indoor unit of the air conditioner.

For another example, first, the intermediate grille 113 is connected to the first grille 111, and the first guiding space 1101 is defined between the intermediate grille 113 and the first grille 111. Subsequently, the second grille 112 is connected to the first grille 111, and the second guiding space 1102 is defined between the second grille 112 and the intermediate grille 113. As such, the filter screen rail module 110 is assembled, and one end of the first guiding space 1101 is in communication with one end of the second guiding space 1102 to form a space for the filter screen 130 to move, and the filter screen 130 is placed in the first guiding space 1101. The assembly method is similar to the previous assembly method, but in the assembly method, the second grille 112 and the intermediate grille 113 are assembled by using the first grille 111 as a positioning reference, such that the positional deviation between the first guiding space 1101 and the second guiding space 1102 can be minimized, and the smooth movement of the filter screen 130 can be ensured.

Specially, as shown in FIG. 1 and FIG. 2, a mounting space 1103 for accommodating a cleaning module 120 is defined by the first grille 111, the second grille 112, and the intermediate grille 113 cooperatively. The first guiding space 1101 is in communication with the second guiding space 1102 through the mounting space 1103, and the cleaning module 120 is configured to drive the filter screen 130 to move in the first guiding space 1101 and the second guiding space 1102 to clean the filter screen 130.

Further, as shown in FIG. 1 and FIG. 2, an end of the first grille 111 is outwardly protruded with respect to an end of the intermediate grille 113 and an end of the second grille 112, and the mounting space 1103 is defined by the end of the first grille 111, the end of the intermediate grille 113, and the end of the second grille 112 cooperatively.

In the present disclosure, as shown in FIG. 2, the first grille 111, the second grille 112 and the intermediate grille 113 are disposed in a superposed manner, and one end of the first grille 111 is protruded. Thus, one end of the first grille 111, one end of the intermediate grille 113 and one end of the second grille 112 together form a mounting space 1103, thereby the mounting space 1103 is defined at one end of the entire filter screen rail module 110 so as to be combined with the cleaning module 120 for saving the internal space of the indoor unit of the air conditioner. The first guiding space 1101 communicates with the mounting space 1103, and the second guiding space 1102 communicates with the mounting space 1103. When the driving structure of the cleaning module 120 drives the filter screen 130, the filter screen 130 enters the mounting space 1103, is thus cleaned, and then enters the second rail 1102. When the filter screen 130 is driven in the reverse direction, the filter screen 130 enters the mounting space 1103 from the second guiding space 1102. At this time, the filter screen 130 may or may not be cleaned, and then enter the first guiding space 1101.

In an embodiment of the present disclosure, the first grille 111 is detachably connected to the second grille 112. In the present embodiment, the detachable connection is a connection manner that can be both fixed and detached by the cooperation of the corresponding structure, such as a screw connection, a key connection, a snap connection, etc., which is not limited in this embodiment. When the filter screen rail module 110 is mounted in the indoor unit of the air conditioner, the air needs to pass through the entire filter screen rail module 110 to exchange heat with the heat exchanger. Therefore, except that the filter screen 130 may be dirty due to the dust accumulated on the filter screen 130, the first grille 111 and the second grille 112 may also become dirty. Thus, in the present embodiment, the first grille 111 is detachably connected to the second grille 112, so that it can be fixed and can be disassembled for easy cleaning.

In the present embodiment, the first grille 111 is detachably connected to the second grille 112, and subsequently, the intermediate grille 113 can be connected to the first grille 111 or the second grille 112, or the first grille 111 and the second grille 112 can jointly form a clamping limit for the intermediate grille 113 when connected.

Specially, the first grille 111 is snap-connected to the second grille 112. In the present embodiment, the snap connection is a type of detachable connection, which is a connection manner in which two parts are embedded or integrally latched. The specific manner of the snap connection is various, for example, the cooperation of the hook and the groove, the cooperation of the claw and the edge, etc., which are not limited in this embodiment. Compared with a threaded connection, the snap connection does not require a screwing operation and the connection of the components is easier.

Of course, in another embodiment, the first grille 111 is connected to the second grille 112 through at least one connection selected from a screw-slot connection, a magnetic connection, or a sliding connection.

In an embodiment of the present disclosure, the intermediate grille 113 is detachably connected to the first grille 111 and/or the second grille 112. As described above, the first grille 111 and the second grille 112 are easily dirty, and the intermediate grille 113 is also easily dirty. To facilitate the cleaning of the intermediate grille 113, the intermediate grille 133 is provided as a detachable connection.

For example, the intermediate grille 113 is detachably connected to the first grille 111. Firstly, the intermediate grille 113 is detachably connected to the first grille 111 to be positioned on the first grille 111, and then the second grille 112 is connected to the first grille 111.

For another example, the intermediate grille 113 is detachably connected to the second grille 112. Firstly, the intermediate grille 113 is detachably connected to the second grille 112 to be positioned on the second grille 112, and then the first grille 111 is connected to the second grille 112.

For another example, the intermediate grille 113 is detachably connected to the first grille 111 and the second grille 112. Firstly, the first grille 111 is connected to the second grille 112, and then the intermediate grille 113 is inserted between the first grille 111 and the second grille 112.

Specially, the intermediate grille 113 is snap-connected to the first grille 111 and/or the second grille 112. In the present embodiment, the snap connection is a type of detachable connection, which is a connection manner in which two parts are embedded or integrally latched. The specific manner of the snap connection is various, for example, the cooperation of the hook and the groove, the cooperation of the claw and the edge, etc., which are not limited in this embodiment. Compared with a threaded connection, the snap connection does not require a screwing operation and the connection of the components is easier.

Of course, in another embodiment, the intermediate grille 113 is connected to the first grille 111 and/or the second grille 112 through a screw-slot connection, a magnetic connection, or a sliding connection.

The present disclosure further provides a cleaning member 100, the cleaning member 100 including a filter screen rail module 110 of any of the above embodiments.

The filter screen rail module 110 is applied to an indoor unit of an air conditioner. The indoor unit of the air conditioner includes a face frame (not shown) defining an air inlet. The filter screen rail module 110 is disposed adjacent to the air inlet, the filter screen rail module 110 is separable from the face frame, and the filter screen rail module 110 is provided with a rail in which the filter screen 130 moves.

The specific structure of the filter screen rail module 110 of the present embodiment refers to the above embodiments. Since the structure of the filter screen rail module 110 of the cleaning member 100 adopts the technical solution of the above embodiments, at least the beneficial effects brought by the technical solutions of the foregoing embodiments are obtained and not repeatedly described herein.

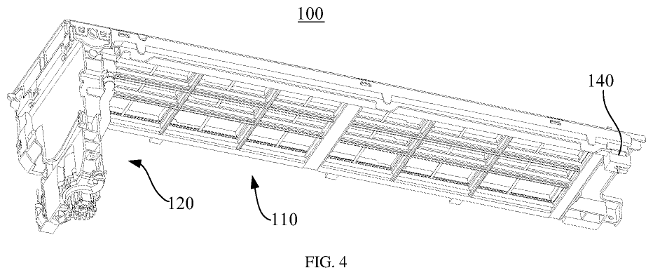

In an embodiment of the present disclosure, as shown in FIG. 4, the cleaning member 100 includes:

a filter screen 130 disposed on the rail; and

a cleaning module 120. The cleaning module 120 is mounted on the filter screen rail module 110. The filter screen 130 is connected to the cleaning module 120. The cleaning module 120 is configured to drive the filter screen 130 to move in the rail for cleaning the filter screen 130.

In the present embodiment, the filter screen 130 is a component for filter screening the air. The filter screen 130 can be disposed in the guiding space. For example, the filter screen 130 can be disposed in the first guiding space 1101 or the second guiding space 1102. One end of the filter screen 130 is drivingly connected to a corresponding component in the cleaning module 120. The cleaning module 120 drives the filter screen 130 to slide out of the first guiding space 1101 into the second guiding space 1102, or slide out the second guiding space 1102 into the first guiding space 1101. For another example, the filter screen 130 is placed in the first guiding space 1101 and the second guiding space 1102, and the cyclic drive is implemented in the first guiding space 1101 and the second guiding space 1102 under the driving of the cleaning module 120.

In an embodiment of the present disclosure, as shown in FIG. 4, the cleaning member further includes a detecting device 140. The detecting device 140 is disposed on the filter screen rail module 110 for detecting a motion state of the filter screen 130. In the present disclosure, the detecting device 140 is disposed on the filter screen rail module 110. For example, the detecting device 140 is fixed to the first grille 111, or fixed to the second grille 112, or fixed to the third or intermediate grille 113. The purpose of the detecting device 140 is to detect whether the filter screen 130 can move within the filter screen rail module 110, and the specific mounting position can be set according to actual needs. As such, by providing the detecting device 140, when the cleaning member 100 and other components are assembled into the indoor unit of the air conditioner, it is not necessary to provide detecting device on other components to detect the movement of the filter screen 130.

Further, the detecting device 140 is a micro switch, the cleaning module 120 is mounted at one end of the filter screen rail module 110, and the micro switch is mounted at another end of the filter screen rail module 110. The filter screen 130 is configured to trigger the micro switch in response to a determination that the filter screen 130 is in contact with the micro switch. In the present embodiment, for example, the micro switch is disposed in the first guiding space 1101 and the second guiding space 1102 so as to be in contact with the filter screen 130. The filter screen 130 contacts the micro switch, and the micro switch generates a signal, and the electronic control module of the indoor unit of the air conditioner can determine whether the filter screen 130 can move normally according to the signal.

The present disclosure further provides an indoor unit of an air conditioner, the indoor unit of the air conditioner including a cleaning member 100 of any of the above embodiments.

The specific structure of the cleaning member 100 of the indoor unit of the air conditioner of the present embodiment refers to the above embodiments. Since the structure of the cleaning member 100 adopts the technical solution of the above embodiments, at least the beneficial effects brought by the technical solutions of the foregoing embodiments are not repeatedly described herein.

In an embodiment of the present disclosure, the indoor unit of the air conditioner including:

a chassis (not shown); and

a face frame (not shown) mounted on the chassis. The cleaning member 100 is mounted on the chassis. The face frame is defined with an air inlet. The filter screen rail module 110 is disposed adjacent to the air inlet. The filter screen rail module 110 is separable from the face frame.

In the present embodiment, the cleaning member 100 is a separate functional component that does not have to cooperate with the face frame to form a rail or guiding space in which the filter screen 130 moves. Therefore, the function of the filter screen 130 can be detected offline, and the normally working cleaning member 100 can be directly mounted on the chassis without cooperating with the face frame, thereby greatly improving the production efficiency.

The above are only alternative embodiments of the present disclosure, and thus do not limit the scope of the present disclosure. The equivalent structure or equivalent process transformations made by the present specification and the drawings are directly or indirectly applied to other related technical fields, and are included in the scope of the present disclosure.

What is claimed is:

1. A filter screen rail module mountable to an indoor unit of an air conditioner, the indoor unit of the air conditioner comprising a face frame defining an air inlet, wherein:
the filter screen rail module is disposed adjacent to the air inlet,
the filter screen rail module is separable from the face frame, and
the filter screen rail module comprises a guiding space, in which the filter screen moves.

2. The filter screen rail module of claim 1, wherein:
the guiding space comprises a first guiding space and a second guiding space communicating with the first guiding space,
the filter screen rail module further comprises:
a first grille;
a second grille spaced apart from the first grille; and
an intermediate grille disposed between the first grille and the second grille, and
the first guiding space is defined between the first grille and the intermediate grille, the second guiding space is defined between the second grille and the intermediate grille, and the filter screen is movable in the first guiding space and the second guiding space.

3. The filter screen rail module of claim 2, further comprising:
a mounting space for accommodating a cleaning module,
wherein the mounting space is defined by the first grille, the second grille and the intermediate grille cooperatively, the first guiding space is in communication with the second guiding space through the mounting space, and the cleaning module is configured to drive the filter screen to move in the first guiding space and the second guiding space to clean the filter screen.

4. The filter screen rail module of claim 3, wherein:
an end of the first grille is outwardly protruded with respect to an end of the intermediate grille and an end of the second grille, and
the mounting space is defined by the end of the first grille, the end of the intermediate grille, and the end of the second grille cooperatively.

5. The filter screen rail module of claim 2, wherein the first grille is detachably connected to the second grille.

6. The filter screen rail module of claim 5, wherein the first grille is connected to the second grille through at least one connection selected from a snap connection, a screw-slot connection, a magnetic connection, or a sliding connection.

7. The filter screen rail module of claim 2, wherein the intermediate grille is detachably connected to the first grille and/or the second grille.

8. The filter screen rail module of claim 7, wherein the intermediate grille is connected to the first grille and/or the second grille through at least one connection selected from a snap connection, a screw-slot connection, a magnetic connection, or a sliding connection.

9. A cleaning member comprising the filter screen rail module according to claim 1.

10. The cleaning member of claim 9, further comprising:
a filter screen disposed in the guiding space; and
a cleaning module mounted on the filter screen rail module,
wherein the filter screen is connected to the cleaning module, and the cleaning module is configured to drive the filter screen to move in the guiding space for cleaning the filter screen.

11. The cleaning member of claim 10, further comprising:
a detecting device disposed on the filter screen rail module for detecting a motion state of the filter screen.

12. The cleaning member of claim 11, wherein the detecting device is a micro switch, the cleaning module is mounted at one end of the filter screen rail module, the micro switch is mounted at another end of the filter screen rail module, and the filter screen is configured to trigger the micro switch in response to a determination that the filter screen is in contact with the micro switch.

13. An indoor unit of an air conditioner, comprising the cleaning member according to claim 9.

14. The indoor unit of the air conditioner of claim 13, further comprising:
a chassis, wherein the cleaning member is mounted on the chassis; and
a face frame mounted on the chassis, and defining an air inlet,
wherein the filter screen rail module is disposed adjacent to the air inlet, and is separable from the face frame.

15. An air conditioner comprising:
the indoor unit according to claim 13; and
an outdoor unit.
